(19) United States
(12) Patent Application Publication
(10) Pub. No.: US 2022/0385548 A1
(43) Pub. Date: Dec. 1, 2022

(54) OPERATIONAL DEVICE OF MAINTENANCE MANAGEMENT SYSTEM, MAINTENANCE MANAGEMENT SYSTEM, OPERATION METHOD AND PROGRAM

(71) Applicant: Nippon Telegraph and Telephone Corporation, Tokyo (JP)

(72) Inventors: Tomoki IKEGAYA, Musashino-shi, Tokyo (JP); Kensuke TAKAHASHI, Musashino-shi, Tokyo (JP); Satoshi KONDO, Musashino-shi, Tokyo (JP)

(21) Appl. No.: 17/773,721

(22) PCT Filed: Nov. 8, 2019
(86) PCT No.: PCT/JP2019/043807

§ 371 Date: May 2, 2022

(51) Int. Cl. H04L 41/34

(52) U.S. Cl. CPC H04L 41/34

(57) ABSTRACT

An operational component according to the present embodiment operates autonomously by transmitting and receiving a message as a part of a maintenance and management system that maintains and manages a service. The operational component includes a message transmission and reception unit that transmits and receives a message to and from another operational component; a firing rule storage unit that holds a firing rule including a trigger for executing an action and the action to be executed; and an action execution unit that executes the action, in the firing rule, to be executed in response to the received message as the trigger. The action execution unit includes one or more action modules that execute an action; an action module execution unit that causes one of the action modules corresponding to the action in the firing rule to execute the action; and a message transmission instruction unit that transmits a message including a result of execution from the action modules.

### TECHNICAL FIELD

The present invention relates to an operation device, a maintenance and management system, an operation method, and a program.

### BACKGROUND ART

With the spread of network environments, the use of services provided via networks is increasing. Service maintenance work is carried out to monitor the quality of a service and whether a failure has occurred in the service, and to analyze and recover the service as necessary. Service maintenance work is done mainly depending on decisions based on the knowledge and know-how of maintainers, which takes time and effort. Especially in recent years, with the spread of B2B2X, the number of services provided in which a plurality of services cooperate with each other is increasing. Service maintenance work also requires maintenance and operation for such cooperative services.

In NPL 1, an autonomous management loop is proposed as a technique for automating service maintenance work in which maintenance operation functions are defined as components to operate autonomously, so that the operation is autonomously determined by simply incorporating a new operational component into the system. In NPL 1, messages are transmitted and received between the operational components classified by function. Each operational component operates autonomously in accordance with a received message.

### CITATION LIST

### Non Patent Literature

[NPL 1] Naoyuki Tanji and two others, “Autonomous Management Loop by Componentization and Autonomization of Operation Function”, IEICE Technical Report, IEICE, July 2018 , Vol. 118, No. 118, pp. 13-18

### SUMMARY OF THE INVENTION

### Technical Problem

The processing executed by each operational component in NPL 1 is original processing created from scratch, resulting in a problem that it takes time and cost to add an operational component to the system. Even in the case of using an external system such as a newly introduced service or an existing service, a method for cooperating with the external system has not been established, so that it is necessary to individually create each of the operational components to be suitable for the external system.

The present invention has been made in view of the foregoing, and an object of the present invention is to introduce operational components classified by function in a short period of time and at low cost in an autonomous management loop.

### Means for Solving the Problem

An operation device according to one aspect of the present invention operates autonomously by transmitting and receiving a message as a part of a maintenance and management system that maintains and manages a service. The operation device includes a message transmission and reception unit that transmits and receives a message to and from another operation device; a firing rule storage unit that holds a firing rule including a trigger for executing an action and the action to be executed; and an action execution unit that executes the action, in the firing rule, to be executed in response to the received message as the trigger, wherein the action execution unit includes one or more action modules that execute an action; an execution unit that causes one of the action modules corresponding to the action in the firing rule to execute the action; and a transmission unit that transmits a message including a result of execution from the action module.

### Effects of the Invention

According to the present invention, it is possible to introduce operational components classified by function in a short period of time and at low cost in an autonomous management loop.

### BRIEF DESCRIPTION OF DRAWINGS

FIG. 1 is a diagram illustrating an example of the overall configuration of a maintenance and management system of an embodiment.

FIG. 2 is a diagram illustrating a configuration example of operational components included in the maintenance and management system.

FIG. 3 is a diagram illustrating a configuration example of an action execution unit.

FIG. 4A illustrates an example of a firing rule.

FIG. 4B illustrates an example of a firing rule.

FIG. 4C illustrates an example of a firing rule.

FIG. 5 illustrates an example of a common part for a message to be transmitted and received.

FIG. 6 illustrates an example of a firing rule in which a post-completion issue message is defined.

FIG. 7 is a sequence diagram illustrating a processing flow of an operational component.

FIG. 8 is a diagram illustrating an example of a hardware configuration of an operational component.

### DESCRIPTION OF EMBODIMENTS

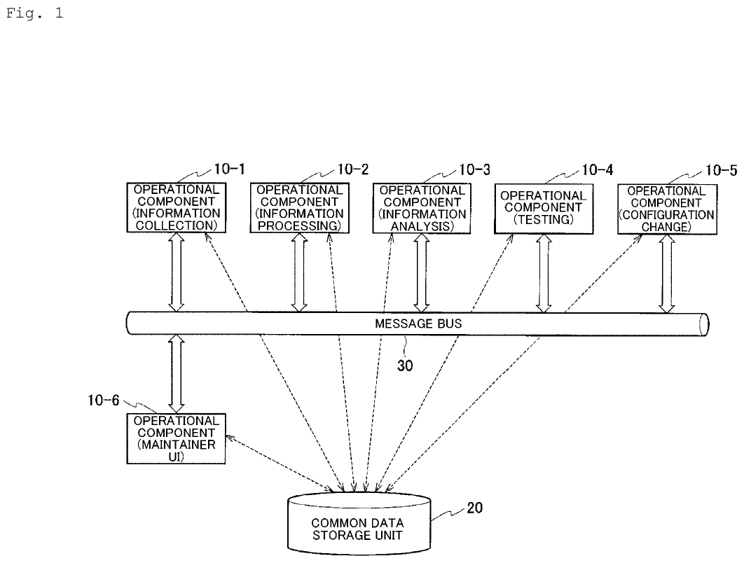

A maintenance and management system of an embodiment will be described with reference to FIG. 1. The maintenance and management system of the present embodiment adopts an autonomous management loop in which operational components 10-1 to 10-6 which have no connection relation therebetween actively check the status of services and alarms and autonomously determine and execute necessary processing.

The operational components 10-1 to 10-6 are devices or processes that operate autonomously. The operational components 10-1 to 10-6 are each componentized in units of maintenance functions so that each has a specific maintenance function. For example, the operational components 10-1 to 10-6 are classified into six function types: information collection, information processing, information analysis, testing, configuration change, and maintainer UI. The outline of the types of operational components are described below.

Information collection: Collect information from the service environment to be maintained.
Information processing: Perform irreversible time series and character string processing, such as noise removal, correlation calculation, feature and keyword extraction, and statistical processing, and visualization.
Information analysis: Perform information analysis, such as classification, prediction, and state estimation for abnormality determination and clustering, and generate results of the analysis.
Testing: Generate and transmit test traffic.
Configuration change: Perform a specific change operation for the service.
Maintainer UI: Provide a user interface for the maintainer to control operational components.

Note that the maintenance and management system may not include all of the above six types of operational components, or may include operational components other than the above-mentioned types. Further, the maintenance and management system may include a plurality of operational components of the same type. For example, for maintenance of a service provided with a plurality of cooperative services, each of the plurality of services is provided with the above-mentioned types of operational components.

The operational components 10-1 to 10-6 transmit and receive a message via a message bus 30. The operational components 10-1 to 10-6 each determine whether to execute an action or do nothing based on the message and the firing rule held by itself.

The message is broadcast to all operational components 10-1 to 10-6 via the message bus 30. The message is a structure such as XML or JSON. The message is composed of a common part that is common to all messages and a specific part that is different for each message type. The common part includes, for example, an ID for identifying the message, a message type, a message transmission time, and the function type and name of an operational component which is the message transmission source. In the present embodiment, the common part is extended to include a field for setting data according to the message type. A result of executing an action is stored in this field. For example, for a message type of “Reply”, the specific part includes the message identifier of the reply source and the response content. For a message type of “Request”, the specific part includes the request content such as information collection interval.

The firing rule is a criterion for the corresponding one of the operational components 10-1 to 10-6 to execute an appropriate action, and includes a trigger for executing the action and information on the action to be executed. The action is processing executed by the corresponding one of the operational components 10-1 to 10-6. In the present embodiment, the firing rule is extended so that the firing rule includes an action executable form and the definition of a result of executing an action to be stored in the message. Each of the operational components 10-1 to 10-6 holds a firing rule individually.

As a specific example, an example of the outline of a firing rule held by each of the operational components 10-1 to 10-6 is described below.

Information collection: Execute a collection action in response to a certain period of time having passed as a trigger.
Information processing: Execute a visualization action in response to a collection notification as a trigger.
Information analysis: Execute an abnormality detection action in response to a collection notification as a trigger. Execute a testing result determination action in response to a testing execution notification as a trigger.
Testing: Transmit a message inquiring whether or not the testing is permitted to be executed in response to an abnormality detection result notification as a trigger. Execute a testing action in response to a testing execution permission notification as a trigger.
Configuration change: Transmit a message inquiring whether or not a restart action or a change action is permitted to be executed in response to a testing result as a trigger. Execute the corresponding action in response to a reply to the execution permission message as a trigger.
Maintainer UI: Executes an action that calls a maintainer in response to an execution permission message that requires the maintainer's determination.

Here, an example of cooperation between the operational component 10-1 to 10-6 is described. In the following, the operational components 10-1 to 10-6 will be described referred to as “information collection functional component”, “information processing functional component”, “information analysis functional component”, “testing functional component”, “configuration change functional component”, and “maintainer UI functional component”, respectively.

First, the information collection functional component collects information in accordance with its own firing rule (e.g., timer expired), and broadcasts a message including the result of collecting the information.

In response to the result of collecting the information as a trigger, the information processing functional component processes the collected information and broadcasts a message including the processed information.

In response to the information having been processed as a trigger, the information analysis functional component detects an abnormality from the processed information and broadcasts a message including a result of detecting the abnormality.

In response to the result of detecting the abnormality as a trigger, the testing functional component selects a test and broadcasts a message inquiring about the execution of the selected test.

In response to the execution inquiry message as a trigger, the maintainer UI functional component obtains permission to execute the test from the maintainer and broadcasts an execution permission message.

In response to the execution permission as a trigger, the testing functional component executes the test and broadcasts a message including the test result.

In response to the test result as a trigger, the configuration change functional component selects an operation that can be executed by the configuration change functional component for the detected abnormality, and broadcasts an execution inquiry message inquiring about the execution of the selected operation.

In response to the execution inquiry message as a trigger, the maintainer UI functional component obtains permission to execute the operation from the maintainer and broadcasts an execution permission message.

In response to the execution permission as a trigger, the configuration change functional component executes the operation and broadcasts a message including the execution result.

In this way, in the maintenance and management system, the operational components 10-1 to 10-6 actively check the conditions, autonomously determine the necessary action, and operate.

The operational components 10-1 to 10-6 store the information commonly utilized by the operational components 10-1 to 10-6 in a common data storage unit 20, and acquire information from the common data storage unit 20 and use the information.

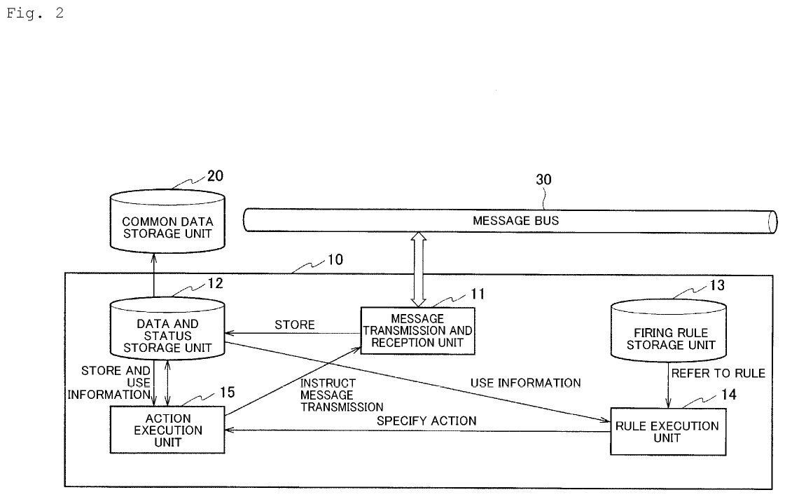

The configuration of each of the operational components included in the maintenance and management system will be described with reference to FIG. 2. The operational components 10-1 to 10-6 in FIG. 1 each have the same configuration as an operational component 10 illustrated in FIG. 2. Hereinafter, when it is not necessary to distinguish the operational components 10-1 to 10-6, they may be simply referred to as the operational component 10.

The operational component 10 includes a message transmission and reception unit 11, a data and status storage unit 12, a firing rule storage unit 13, a rule execution unit 14, and an action execution unit 15.

The message transmission and reception unit 11 transmits and receives a message via the message bus 30. The message is broadcasted to all operational components 10-1 to 10-6 via the message bus 30.

The data and status storage unit 12 holds data, such as a received message and a result of execution from the action execution unit 15, and a status. The data and status storage unit 12 may hold the data acquired from the common data storage unit 20, or may temporarily hold data to be stored in the common data storage unit 20 and then store the data in the common data storage unit 20. The data and status held in the data and status storage unit 12 may be used when the action execution unit 15 executes an action.

The firing rule storage unit 13 holds a firing rule in which a trigger for executing an action and information related to the action are defined individually for each of the operational components 10-1 to 10-6. The firing rule includes, as information about the action, an action executable form and the definition of a result of execution to be included in a message of action completion. The firing rule includes action information set for each executable form, such as the content of a request to be transmitted or a command to be executed. The details of the firing rule will be described later.

The rule execution unit 14 monitors the trigger for executing an action based on the received message and the firing rule stored in the firing rule storage unit 13. When the rule execution unit 14 recognizes the action to be executed, the rule execution unit 14 instructs the action execution unit 15 to execute the corresponding action. More specifically, the rule execution unit 14 determines whether or not the firing rule in which the type of the message received by the message transmission and reception unit 11 is used as the trigger for executing the action is stored in the firing rule storage unit 13. When the corresponding firing rule is stored, the rule execution unit 14 acquires the action executable form and information on the action from the firing rule and notifies the action execution unit 15 of them. The rule execution unit 14 may pass the firing rule to the action execution unit 15 to instruct the execution of the action. Further, the rule execution unit 14 may pass the message that is the trigger for executing the action to the action execution unit 15.

In response to an instruction from the rule execution unit 14, the action execution unit 15 executes the action in the executable form specified therein. When the action is completed, the action execution unit 15 instructs the message transmission and reception unit 11 to transmit a message including the result of executing the action.

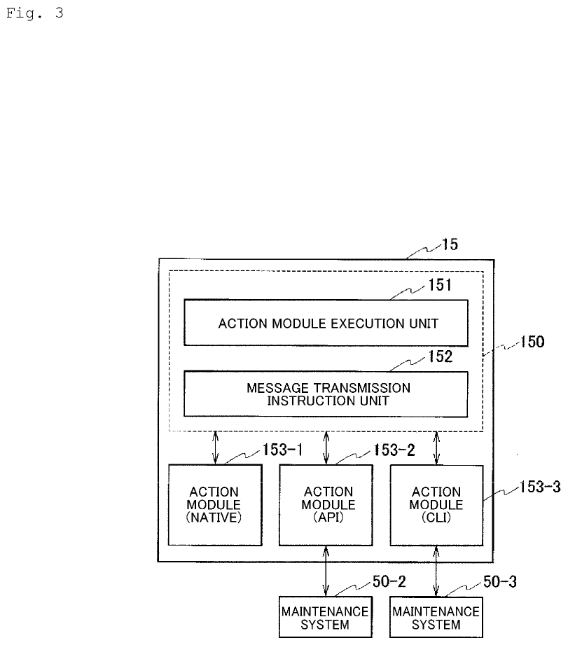

The action execution unit 15 will be described with reference to FIG. 3. As illustrated in FIG. 3, the action execution unit 15 includes an action module execution unit 151, a message transmission instruction unit 152, and one or more action modules 153-1 to 153-3.

The action module execution unit 151 passes information related to the action to the corresponding one of the action modules 153-1 to 153-3 which supports the specified executable form, and causes the action module to execute the action. The action module execution unit 151 may acquire information necessary for executing the action from the data and status storage unit 12 and the common data storage unit 20, and pass the information to the corresponding one of the action modules 153-1 to 153-3.

The message transmission instruction unit 152 instructs the message transmission and reception unit 11 to transmit a message including the execution result from the corresponding one of the action modules 153-1 to 153-3.

The action module execution unit 151 and the message transmission instruction unit 152 constitute an action cooperation unit 150. Each of the operational components 10-1 to 10-6 includes the action cooperation unit 150 which is common between them.

Each of the action modules 153-1 to 153-3 is a module that executes an action that implements the function of the corresponding one of the operational components 10-1 to 10-6. FIG. 3 illustrates three action modules 153-1 to 153-3, but not limited thereto.

The action module is classified into the action module 153-1 that executes the processing natively and the action modules 153-2 and 153-3 that each execute the processing in a predetermined executable form. Each of the action modules 153-2 and 153-3 executes the processing in a different executable form. The action modules 153-2 and 153-3 execute the processing for external maintenance systems 50-2 and 50-3, respectively, in the set executable forms. FIG. 3 illustrates the action module 153-2 that executes the processing by an application programming interface (API) and the action module 153-3 that executes the processing by a command line interface (CLI). The maintenance system 50-2 is a system that provides services by the API. The maintenance system 50-3 is a system that provides services in response to commands.

By preparing the action modules 153-2 and 153-3 for the executable forms of the maintenance systems 50-2 and 50-3, respectively, the operational components 10-1 to 10-6 can use the common action modules 153-2 and 153-3. For example, for an external system that provides services through HTTP requests, the action module 153-2 can be used, and for an external system that provides services through commands, the action module 153-3 can be used. Each of the operational components 10-1 to 10-6, which can use an external system, includes the action modules 153-2 and 153-3 one of which supports the interface for the external system, and a request or command to use the external system can be described in the firing rule.

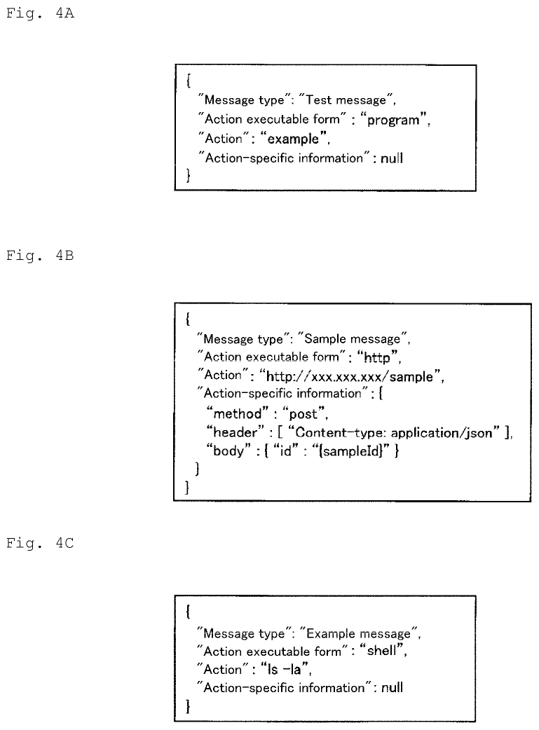

With reference to FIGS. 4A, 4B, and 4C, firing rules including the action executable forms corresponding respectively to the action modules 153-1 to 153-3 will be described.

FIGS. 4A, 4B, and 4C illustrate examples of the firing rules held in the firing rule storage unit 13. The firing rule includes a message type, an action executable form, an action, and action-specific information. The message type defines a message that is used as a trigger to execute the action. The action executable form defines information for specifying one of the action modules 153-1 to 153-3 that executes the action. The action defines the action to be executed by the action modules 153-1 to 153-3. The action-specific information defines information necessary for executing the action.

FIG. 4A is an example of the firing rule for the action module 153-1 to execute the action by the native processing. The action execution unit 15 passes the action defined in FIG. 4A to the action module 153-1. The action module 153-1 then executes the specified action.

FIG. 4B is an example of the firing rule for the action module 153-2 to execute the action using the API. The action execution unit 15 passes the action and the action-specific information defined in FIG. 4B to the action module 153-2. The action module 153-2 transmits a request whose content is described in the action-specific information to the URL specified in the action. Further, the action-specific information may include a variable value to be replaced by the message content, such as “{sampleId}”.

FIG. 4C is an example of the firing rule for the action module 153-3 to receive an input of a command to execute an action. The action execution unit 15 passes the action defined in FIG. 4C to the action module 153-3. The action module 153-3 accesses the maintenance system 50-3, receives an input of the command specified in the action to execute. Options to be added to the command may be defined in the action-specific information.

In the conventional technique of NPL 1, the firing rule includes only a message type and an action. When the action is specified, an action execution unit executes native processing defined in the action execution unit. In the present embodiment, including an action executable form in a firing rule makes it possible to specify an action module to execute an action so as to provide a common action module that is common between the operational components 10-1 to 10-6. When any one of the operational components 10-1 to 10-6 executes its native processing without using an external system, the action module 153-1 that executes the native processing may be created.

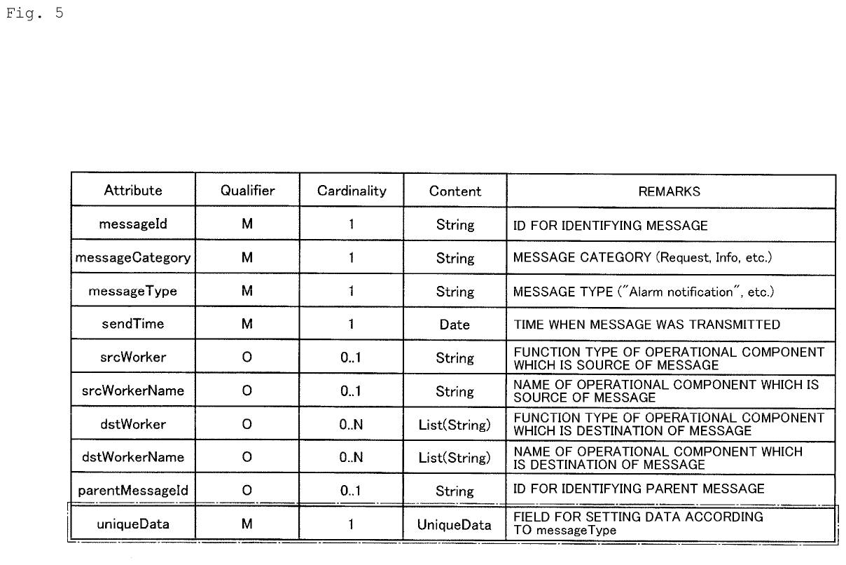

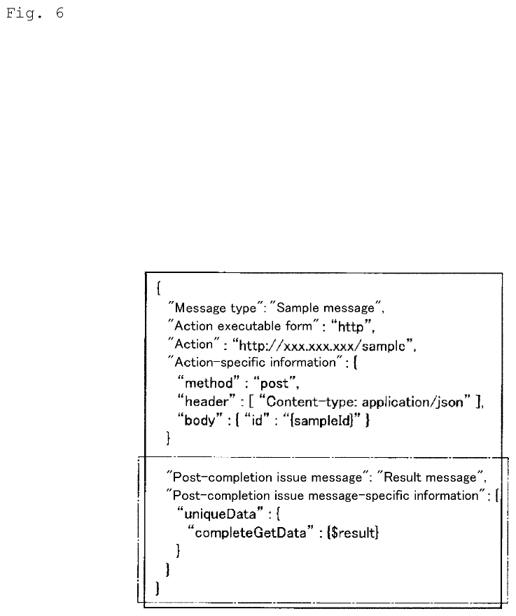

With reference to FIGS. 5 and 6, a method of converting individual results of executing actions into messages in the same format will be described.

A common part for a message illustrated in FIG. 5 includes a field (uniqueData) for setting data according to the message type. When the message transmission instruction unit 152 receives a result of executing the action from the action modules 153-1 to 153-3, the message transmission instruction unit 152 instructs the message transmission and reception unit 11 to transmit a message including the result of executing the action in this field.

As illustrated in FIG. 6, the result of executing the action to be included in the message is defined in the firing rule. FIG. 6 illustrates an extension of the firing rule of FIG. 4B. In a post-completion issue message, a message type in which the result of executing the action is to be included is defined. In a post-completion issue message-specific information, the result of execution to be included in uniqueData of the message common part is defined. The post-completion issue message-specific information may include a variable value to be replaced with the information of the result of execution, such as “{$result}”. For example, it may include the main body part of a response to the request transmitted by the action module 153-2.

Note that the firing rules of FIGS. 4A and 4C may also define a post-completion issue message.

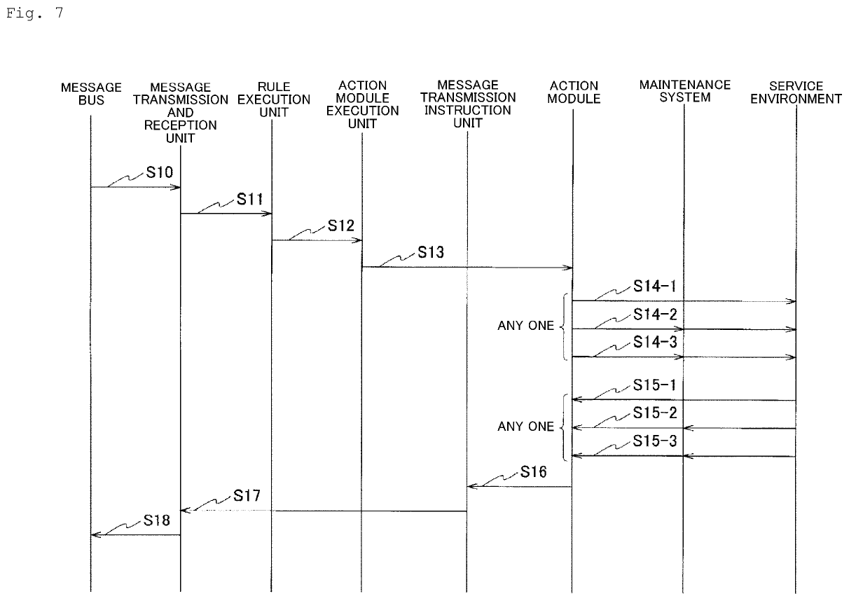

The operation of the operational component 10 will be described with reference to FIG. 7.

In step S10, the message transmission and reception unit 11 receives a message from the message bus 30.

In step S11, the rule execution unit 14 determines whether or not there is a firing rule corresponding to the message in the firing rule storage unit 13, that is, whether or not it is the trigger for executing an action. If the received message does not indicate the trigger for executing the action, the operational component 10 ends the processing.

If there is a firing rule corresponding to the message, in step S12, the rule execution unit 14 issues to the action module execution unit 151 an instruction to execute the specified action in the action executable form of the firing rule.

Instep S13, the action module execution unit 151 selects one of the action modules 153-1 to 153-3 corresponding to the action executable form, and causes the specified action to be executed.

If the action module 153-1 that executes the native processing is selected, in step S14-1, the action module 153-1 executes the native processing to acquire information from a service environment to be maintained, or do a test for the service environment. The action module 153-1 may perform processing other than processing for the service environment.

In step S15-1, the action module 153-1 obtains a result of executing the action from the service environment.

If the action module 153-2 using the API is selected, in step S14-2, the action module 153-2 transmits a request using the API to the maintenance system 50-2. The maintenance system 50-2 executes processing according to the request.

In step S15-2, the action module 153-2 receives a response from the maintenance system 50-2.

If the action module 153-3 using the CLI is selected, in step S14-3, the action module 153-3 requests the maintenance system 50-3 to execute a specified command. The maintenance system 50-3 executes processing according to the command.

In step S15-3, the action module 153-3 obtains a result of executing the command from the maintenance system 50-3.

In step S16, the message transmission instruction unit 152 acquires a result of executing the action from the action modules 153-1 to 153-3.

In step S17, the message transmission instruction unit 152 instructs the message transmission and reception unit 11 to transmit a message including the result of executing the action.

In step S18, the message transmission and reception unit 11 transmits a message including the result of executing the action to the message bus 30.

The message transmitted to the message bus 30 is broadcasted to all the operational components 10-1 to 10-6. Each of the operational components 10-1 to 10-6 receives the message and executes the processing beginning at step S10.

The operational component 10 according to the present embodiment operates autonomously by transmitting and receiving a message as a part of a maintenance and management system that maintains and manages a service. The operational component 10 includes the message transmission and reception unit 11 that transmits and receives a message to and from another operational component 10; the firing rule storage unit 13 that holds a firing rule including a trigger for executing an action and the action to be executed; and the action execution unit 15 that executes the action, in the firing rule, to be executed in response to the received message as the trigger. The action execution unit 15 includes one or more action modules 153-1 to 153-3 that execute an action; the action module execution unit 151 that causes one of the action modules 153-1 to 153-3 corresponding to the action in the firing rule to execute the action; and the message transmission instruction unit 152 that transmits a message including a result of execution from the action module. As a result, the operational component 10 can be introduced only by creating a firing rule and creating the action modules 153-1 to 153-3 that execute an action of the firing rule.

In the operational component 10 according to the present embodiment, the firing rule includes an action executable form and action information set for each executable form, and the action module execution unit 151 causes the action module 153-2 or 153-3 corresponding to the executable form to execute an action based on the action information. As a result, the operational component 10 can easily use various forms of external systems such as HTTP requests or shell commands only by being provided with the action modules 153-2 and 153-3. Therefore, it is possible to introduce the operational component 10 using an external system in a short period of time and at low cost.

In the operational component 10 according to the present embodiment, a message has a field in which a result of executing an action is included, and in a firing rule, the result of executing the action to be included in the message is defined. As a result, the operational components 10 can convert the individual results of execution from the operational components 10 into messages, so that the results of execution can be easily used among the operational components 10.

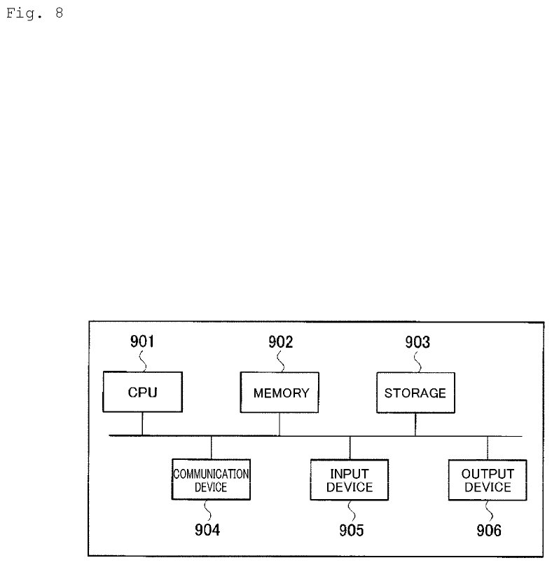

The operational component 10 described above may use a general-purpose computer system that includes, for example, a central processing unit (CPU) 901, a memory 902, a storage 903, a communication device 904, an input device 905, and an output device 906, as illustrated in FIG. 8. In this computer system, the operational component 10 is realized by the CPU 901 executing a predetermined program loaded into the memory 902. This program can be recorded on a computer-readable recording medium such as a magnetic disk, an optical disc, or a semiconductor memory, or can be distributed via a network.

Note that a single computer may operate as one operational component 10, or may operate as a plurality of operational components 10. Further, a virtual machine operating on the cloud may be operated as the operational component(s) 10.

### REFERENCE SIGNS LIST

10,10-1 to 10-6 Operational component

11 Message transmission and reception unit

12 Data and status storage unit

13 Firing rule storage unit

14 Rule execution unit

15 Action execution unit

150 Action cooperation unit

151 Action module execution unit

152 Message transmission instruction unit

153-1 to 153-3 Action module

20 Common data storage unit

30 Message bus

1. An operation device that operates autonomously by transmitting and receiving a message as a part of a maintenance and management system that maintains and manages a service, the operation device comprising one or more processors configured to:
transmit and receive a message to and from another operation device;
hold a firing rule including a trigger for executing an action and the action to be executed; and
execute the action, in the firing rule, to be executed in response to the received message as the trigger,
wherein executing the action comprises:
causing one action module, included in one or more action modules, corresponding to the action in the firing rule to execute the action; and
transmitting a message including a result of execution from the action module.

2. The operation device according to claim 1, wherein
the firing rule includes an executable form of the action and action information set for each executable form, and
executing the action comprises: causing the action module corresponding to the executable form to execute the action based on the action information.

3. The operation device according to claim 1, wherein
the message has a field in which a result of executing the action is included, and
the firing rule has a definition of the result of executing the action to be included in the message.

4. A maintenance and management system that maintains and manages a service, the maintenance and management system comprising a plurality of operation devices according to claim 1.

5. An operation method performed by an operation device that operates autonomously by transmitting and receiving a message as a part of a maintenance and management system that maintains and manages a service,
the operation device holding a firing rule including a trigger for executing an action and the action to be executed,
the operation method comprising:
transmitting and receiving a message to and from another operation device; and
executing the action, in the firing rule, to be executed in response to the received message as the trigger,
wherein executing the action includes:
causing one of action modules corresponding to the action in the firing rule to execute the action; and
transmitting a message including a result of execution from the action module.

6. The operation method according to claim 5, wherein
the firing rule includes an executable form of the action and action information set for each executable form, and
executing the action includes causing the action module corresponding to the executable form to execute the action based on the action information.

7. The operation method according to claim 5, wherein
the message has a field in which a result of executing the action is included, and
the firing rule has a definition of the result of executing the action to be included in the message.

8. A non-transitory computer readable medium storing one or more instructions causing a computer to function as an operation device, that operates autonomously by transmitting and receiving a message as a part of a maintenance and management system that maintains and manages a service, to execute:
holding a firing rule including a trigger for executing an action and the action to be executed;
transmitting and receiving a message to and from another operation device; and
executing the action, in the firing rule, to be executed in response to the received message as the trigger,
wherein executing the action includes:
causing one of action modules corresponding to the action in the firing rule to execute the action; and
transmitting a message including a result of execution from the action module.

9. The non-transitory computer readable medium according to claim 8, wherein
the firing rule includes an executable form of the action and action information set for each executable form, and
executing the action includes causing the action module corresponding to the executable form to execute the action based on the action information.

10. The non-transitory computer readable medium according to claim 8, wherein
the message has a field in which a result of executing the action is included, and
the firing rule has a definition of the result of executing the action to be included in the message.
